(19) United States
(12) Patent Application Publication
(10) Pub. No.: US 2016/0140586 A1
(43) Pub. Date: May 19, 2016

(54) BEHAVIORAL DEMAND RESPONSE USING SUBSTATION METER DATA

(71) Applicant: Opower, Inc., Arlington, VA (US)

(72) Inventors: Alexandra Liptsey-Rahe, San Francisco, CA (US); Tom Mercer, San Francisco, CA (US); Alessandro Orfei, San Francisco, CA (US); Alex Kinnier, Bethesda, MD (US)

(21) Appl. No.: 14/700,590

(22) Filed: Apr. 30, 2015

Related U.S. Application Data
(60) Provisional application No. 62/079,702, filed on Nov. 14, 2014.

(51) Int. Cl. G06Q 30/02

(52) U.S. Cl. CPC G06Q 30/0202

(57) ABSTRACT

Methods and systems for using substation meter data in one or more applications related behavior demand response are provided. In one example application, substation meter data may be used to assess the efficacy of a demand response campaign. In a second example application, substation meter data may be used to provide comparisons of demand response performances of neighborhoods. These applications may be applied independently or in combination.

### CROSS-REFERENCE TO RELATED APPLICATIONS

The present application claims the benefit of priority to U.S. Provisional Application Ser. No. 62/079,702, filed Nov. 14, 2014, entitled “BEHAVIORAL DEMAND RESPONSE USING SUBSTATION METER DATA,” which is hereby incorporated by reference in its entirety.

### BACKGROUND

The subject technology generally relates to behavioral demand response using substation meter data.

Peak resource consumption events or “peak events” can occur multiple times per year for a given resource (e.g., electricity, gas, or water). For example, a peak event for a utility may occur during one or more hot days due to heavy air-conditioning loads. During a peak event, a resource provider (e.g., utility) may have difficulty meeting demand, which may result in a blackout, higher utility rates, and/or a need to put one or more additional electric power generators online.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In one aspect, a computer-implemented method is provided. The method comprises receiving first meter data for at least one substation in a treatment group during a demand response event, wherein a plurality of customers served by the at least one substation receive communications associated with a campaign for the demand response event. The method also comprises receiving second meter data for at least one substation in a control group during the demand response event. The method further comprises measuring efficacy of the campaign based at least in part on the first meter data and the second meter data.

In a second aspect, a system is provided. The system comprises a computer processor, and a memory storing instructions. The instructions, when executed by the computer processor, cause the computer processor to receive first meter data for at least one substation in a treatment group during a demand response event, wherein a plurality of customers served by the at least one substation receive communications associated with a campaign for the demand response event. The instructions, when executed by the computer processor, also cause the computer processor to receive second meter data for at least one substation in a control group during the demand response event, and measure efficacy of the campaign based at least in part on the first meter data and the second meter data.

In a third aspect, a non-transitory computer-readable medium storing instructions is provided. The instructions, when executed by a computer processor, cause the computer processor to receive first meter data for at least one substation in a treatment group during a demand response event, wherein a plurality of customers served by the at least one substation receive communications associated with a campaign for the demand response event. The instructions, when executed by the computer processor, also cause the computer processor to receive second meter data for at least one substation in a control group during the demand response event, and measure efficacy of the campaign based at least in part on the first meter data and the second meter data.

In a fourth aspect, a computer-implemented method is provided. The method comprises identifying at least two similar substations, receiving meter data for each one of the similar substations during a demand response event, generating a comparison of usages of the similar substations during the demand response event based at least in part on the meter data for the similar substations, and providing the comparison to at least one customer of the similar substations.

In a fifth aspect, a system is provided. The system comprises a computer processor, and a memory storing instructions. The instructions, when executed by the computer processor, cause the computer processor to identify at least two similar substations, receive meter data for each one of the similar substations during a demand response event, generate a comparison of usages of the similar substations during the demand response event based at least in part on the meter data for the similar substations, and provide the comparison to at least one customer of the similar substations.

In a sixth aspect, a non-transitory computer-readable medium storing instructions is provided. The instructions, when executed by a computer processor, cause the computer processor to identify at least two similar substations, receive meter data for each one of the similar substations during a demand response event, generate a comparison of usages of the similar substations during the demand response event based at least in part on the meter data for the similar substations, and provide the comparison to at least one customer of the similar substations

### BRIEF DESCRIPTION OF THE DRAWINGS

In the following description, reference is made to the following figures, and in which are shown by way of illustration specific embodiments in which the subject technology may be practiced. It is to be understood that other embodiments may be utilized and changes may be made without departing from the scope of the subject technology.

FIG. 1 illustrates an example of an environment in which aspects of the subject technology may be implemented.

FIG. 2 is a flowchart illustrating an exemplary process for measuring efficacy of a demand response campaign using substation meter data according to aspects of the subject technology.

FIG. 3 is a flowchart illustrating another exemplary process for measuring efficacy of a demand response campaign using substation meter data according to aspects of the subject technology.

FIG. 4 is a flowchart illustrating an exemplary process for comparing demand response performances of neighborhoods according to aspects of the subject technology.

FIG. 5 shows an example of a pre-event notification according to aspects of the subject technology.

FIG. 6 shows another example of a pre-event notification according to aspects of the subject technology.

FIG. 7 shows an example of a post-event notification according to aspects of the subject technology.

FIG. 8 shows another example of a post-event notification according to aspects of the subject technology.

FIG. 9 illustrates an electronic system with which features of the subject technology may be implemented.

FIG. 10 illustrates an example of an environment for implementing aspects of the subject technology in accordance with various embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Peak resource consumption events or “peak events” can occur multiple times per year for a given resource (e.g., electricity, gas, or water). For example, a peak event for a utility may occur during one or more hot days due to heavy air-conditioning loads. During a peak event, a resource provider (e.g., utility) may have difficulty meeting demand, which may result in a blackout, higher utility rates, and/or a need to put one or more additional electric power generators online.

To address this problem, resource providers (e.g., utility company) may initiate a demand response event to reduce resource demand during a peak event. A demand response event may refer to actions that are taken to reduce resource energy demand during a peak event. A demand response event may involve implementing a demand response campaign or program, in which communications are sent to utility customers (e.g., via electronic mail, regular mail, etc.) before the peak event. Each communication may inform the respective customer of the upcoming peak event and ask the customer to reduce usage during the peak event. After the peak event, each customer may receive a post-event notification providing the customer with feedback on how much energy he/she saved during the peak event (e.g., compared to a previous peak event and/or other customers).

There are many different ways to implement demand response campaigns with varying degrees of success. Therefore, it is desirable to measure the efficacy of a demand response campaign. In one approach, the efficacy of a demand response campaign may be measured using Advanced Metering Infrastructure (AMI) data at the customer level. In this approach, usage data for each customer is collected from a meter device (e.g., smart meter) located at the customer's property, in which the meter device provides usage data for the customer in short time intervals (e.g., intervals of one hour or less). Each customer's resource usage during the peak event is then determined based on the usage data collected from the respective meter device. This determination is enabled by the short time intervals in which usage is measured by the respective meter device.

In this approach, a first group of customers may be assigned to a control group and a second group of customers may be assigned to a treatment group. The customers may be randomly assigned to the groups so that each group is representative of the population. Customers in the treatment group are enrolled in the demand response campaign being tested, and customers in the control group are not enrolled in the demand response campaign. As a result, customers in the treatment group receive notifications associated with the demand response campaign while customers in the control group do not. After the peak event, usage data for the treatment group may be compared to usage data for the control group to measure the efficacy of the demand response campaign. For example, the usage data for the treatment group may be compared with the usage data for the control group to determine whether customers in the treatment group out performed customers in the control group.

This approach is useful when AMI data at the customer level is available. However, smart meters are more expensive than traditional meters and are currently not in wide use. As a result, AMI data at the customer level may not be available to measure the efficacy of a demand response campaign. Accordingly, another method for measuring the efficacy of a demand response campaign is needed.

In one embodiment, the efficacy of a demand response campaign is measured using AMI data at the substation level, where each substation provides resources (e.g., electricity, gas, water) to a plurality of customers. Thus, in this embodiment, usage data during the peak event is collected for each substation. The usage data for each substation corresponds to the usage data for an aggregate of the customers served by the substation.

A control group and a treatment group may be formed to measure the efficacy of the demand response campaign, where each group comprises one or more substations. In one example, the control and treatment groups may be populated with substations using pair-wise randomization. In this example, each one of a plurality of substations is paired with a similar substation (e.g., a substation with a similar load, similar usage, etc.). For each pair of substations, one of the substations in the pair is assigned to the control group and the other one of the substations in the pair is assigned to the treatment group. The pair-wise randomization helps ensure that the control group and the treatment group are statistically equivalent. It is to be appreciated that the subject technology is not limited to this example, and that the treatment and control groups may be populated using other techniques, as discussed further below.

After the groups are formed, customers in the treatment group are enrolled in the demand response campaign (e.g., receive pre-event notifications) while customers in the control group are not. After the peak event, usage data for the control group during the peak event may be compared with usage data for the treatment group to measure the efficacy of the campaign. For example, the usage data for the treatment group and control group may be used to determine whether the treatment group reduced usage during the peak event compared to the control group. Thus, the efficacy of the demand response campaign can be measured using usage data collected at the substation level.

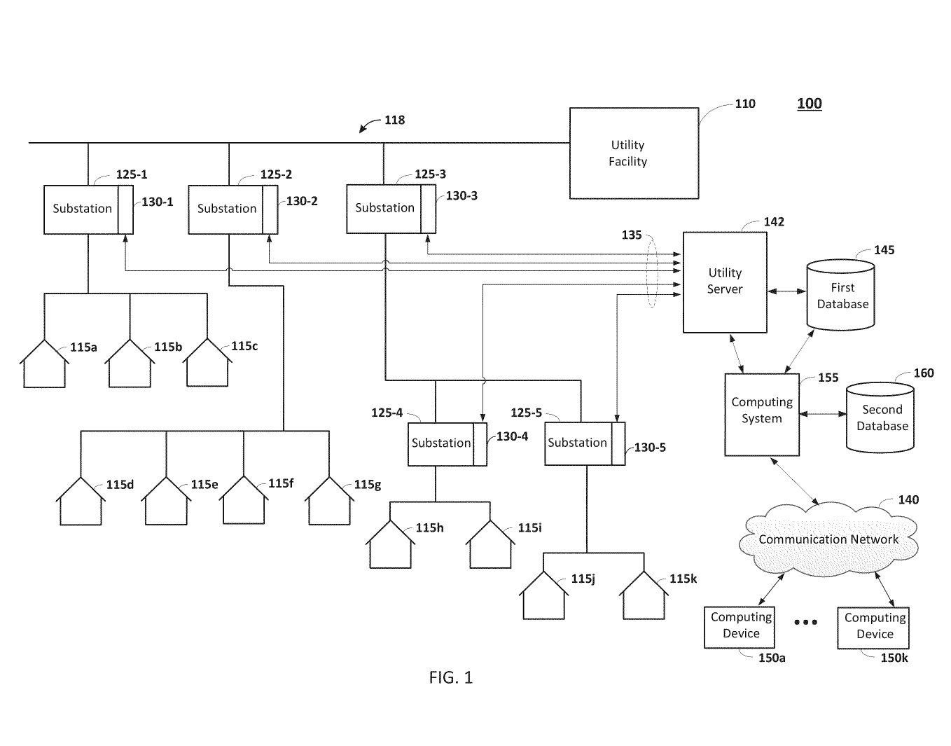

Before discussing various embodiments of the subject technology in more detail, it may be useful to describe an exemplary environment in which various aspects of the subject technology may be implemented. In this regard, FIG. 1 shows an exemplary environment 100 including a utility facility 110 that provides resources (e.g., electricity, gas, water) to a plurality of properties 115a-115k (e.g., residential homes, apartments, commercial buildings, etc.) over a geographical area. Each property 115a-115k may be associated with a utility customer (e.g., a customer residing at the property, a customer responsible for paying for resources consumed at the property, etc.). Although eleven properties 115a-115k are shown in FIG. 1 for ease of illustration, it is to be appreciated that the environment 100 may include a much larger number of properties.

The utility facility 110 provides resources to the properties 115a-115k via a distribution network 118. For the example in which the resource is electricity, the distribution network 118 may comprise an electrical grid that distributes electricity from an electric generator at the utility facility 110 to the properties 115a-115k. For the example in which the resource is natural gas, the distribution network 118 may comprise a network of pipes that distribute gas from a storage facility at the utility facility 110 to the properties 115a-115k.

The delivery network 118 comprises a plurality of substations 125-1 to 125-5, where each substation 125-1 to 125-5 provides resources to a subset of the properties 115a-115k located downstream of the substation. For example, substation 125-1 provides resources to properties 115a-115c, substation 125-2 provides resources to properties 115d-115g, and substation 125-3 provides resources to properties 115h-115k. It is to be appreciated that there may be more than one substation between the utility facility 110 and a particularly property. In this regard, FIG. 1 shows an example in which the resources passing through substation 125-3 are divided among substations 125-4 and 125-5 located downstream of substation 125-3, where substation 125-4 provides resources to properties 115h and 115i and substation 125-5 provides resources to properties 115j and 115k. It to be appreciated that the delivery network 118 may include a much larger number of substations than shown in FIG. 1. It is also to be appreciated that each substation may serve a much larger number of properties than shown in FIG. 1.

For the example in which the resource is electricity, each of the substations 125-1 to 125-5 is configured to serve a portion of the electrical distribution network 118, and distribute electricity to multiple properties (also referred to as parcels) within that portion of the network 118. In some cases, a substation may feed additional substations, directly feed one or more properties, or a combination thereof. For example, substation 125-3 may feed substations 125-4 and 125-5 as shown in FIG. 1, and substation 125-4 may directly feed properties 115h and 115j.

Using the example in which the resource is electricity, a substation may comprise one or more transformers for converting high-voltage electricity from the utility facility 110 into low-voltage electricity for use by the properties served by the substation. In this example, electricity from the utility facility 110 may be transmitted to the substation at high voltage to facilitate the efficient transport of electricity to the substation. In another example, a substation may comprise one or more switches for controlling the flow of electricity to properties located downstream of the substation (properties served by the substation). In this example, the substation may use the one or more switches to shut off electricity to one or more of the properties when there is a fault (e.g., downed transmission line, overload condition, etc.) between the substation and the one or more of the properties. This may be done, for example, to isolate the fault from the rest of the electric distribution network or grid. In this example, the substation may be referred to as a switching substation. It is to be appreciated that a substation may include both a transformer and a switch or just one of these types of components. It is also to be appreciated that the subject technology is not limited to the exemplary substations discussed above.

In the example in FIG. 1, the environment 100 includes a meter device 130-1 to 130-5 at each substation. Each meter device 130-1 to 130-5 may comprise an electronic device (e.g., metering device) configured to measure the amount of resources (e.g., a smart meter device may be configured to measure the amount of resources in real-time and/or short intervals of an hour or less) passing through the substation, and to communicate corresponding meter data to a utility server 142 via a communication channel 135 for monitoring purposes. The communication channel 135 may comprise a wired link, a wireless link, or a combination thereof. Since the resources passing through a substation are provided to the properties served by the substation, the meter data from the respective meter device indicates the amount of resources used (consumed) by an aggregate of these properties. Upon receiving meter data from one of the meter devices 130-1 to 130-5, the utility server 142 stores the meter data in a first database 145, in which the stored meter data may be associated with the corresponding substation. The first database 145 may also store information related to the geographical area served by each substation including one or more area codes, zip codes, cities, or neighborhoods served. The first database 145 may also store information related to the utility customers served by each substation, including customer account information, contact information (e.g., home address, email address, phone number, etc.), or other profile information for the utility customers. It is to be appreciated that the utility server 142 in FIG. 1 may represent a single computing system or a plurality of interconnected computing systems that perform one or more of the functions described herein. It is also to be appreciated that the first database 145 may represent one or more databases.

It is to be appreciated that the subject technology may be applied to any grid-level data that aggregates loads on a grid node. For example, a meter device at a grid node may measure the amount of resources (e.g., electricity) passing through the grid node to a plurality of properties. In this example, the resulting meter data indicates the amount of resources used by an aggregate of the properties. The meter device may send the meter data to the utility server 142, which may store the meter data in the first database 145 and associate the meter data with the corresponding properties. In another example, a meter device at a distribution transformer may measure the amount of resources (e.g., electricity) provided by the distribution transformer to a plurality of properties. The distribution transformer may transform the voltage level of the resources to the final voltage level delivered to the properties. In this example, the resulting meter data indicates the amount of resources used by an aggregate of the properties. The meter device may send the meter data to the utility server 142, which may store the meter data in the first database 145 and associate the meter data with the corresponding properties. Accordingly, it is to be understood that the term “substation” as used herein may apply to any grid-level node at which the loads of a plurality of properties are aggregated.

The environment 100 may also comprise a computing system 155 configured to communicate with the utility server 142 and/or the first database 145 (e.g., via a wired connection, a wireless connection, a network, etc.). The computing system 155 may retrieve information from the first database 145 needed to perform operations described herein, and store the retrieved information in a second database 160. The information may include meter data for the substations and information (e.g., contact information) for utility customers served by the substations. Thus, the second database 160 may be used to consolidate information needed by the computing system 155 to perform operations described herein. The computing system 155 may retrieved the information directly from the first database 145 (e.g., if the computing system 155 is granted direct access to the first database 145). Alternatively, the computing system 155 may request information from the utility server 142 and/or a third party. In response, the utility server 142 may retrieve the information from the first database 145, and forward the retrieved information to the computing system 155. Additionally, or alternatively, the computing system 155 may request and retrieve information from a third party not shown in FIG. 1.

The environment 100 may also comprise one or more computing devices 150a-150k for each of the utility customers associated with the properties 115a-115k. The computing devices may also be referred to as client devices, user devices or other terminology. A computing device may comprise a mobile device (e.g., mobile phone), a computer, a laptop, and/or a tablet of the respective utility customer. A computing device may also comprise a climate control device (e.g., smart thermostat) or other smart appliance that is able to receive information (e.g., set point) over a communication network, and provide the information to the respective customer. In this example, the computing system 155 may communicate information (e.g., pre-event notification, post-event notification, etc.) to a utility customer by sending the information to the respective computing device 150a-150k via a communication network 140. In this regard, the communication network 140 may comprise a cellular network, the Internet, other type of network, or a combination thereof. The information may be sent in the form of a text message (e.g., short message service (SMS) message), an email, an automated voice message, etc. Upon receiving the information, the computing device may display the information to the respective customer using a mobile application, a text-message application, an electronic-mail application, etc. It is to be appreciated that the communication network 140 in FIG. 1 may represent one or more networks.

Exemplary systems and methods for measuring the efficacy of a demand response campaign will now be described according to various embodiments of the subject technology.

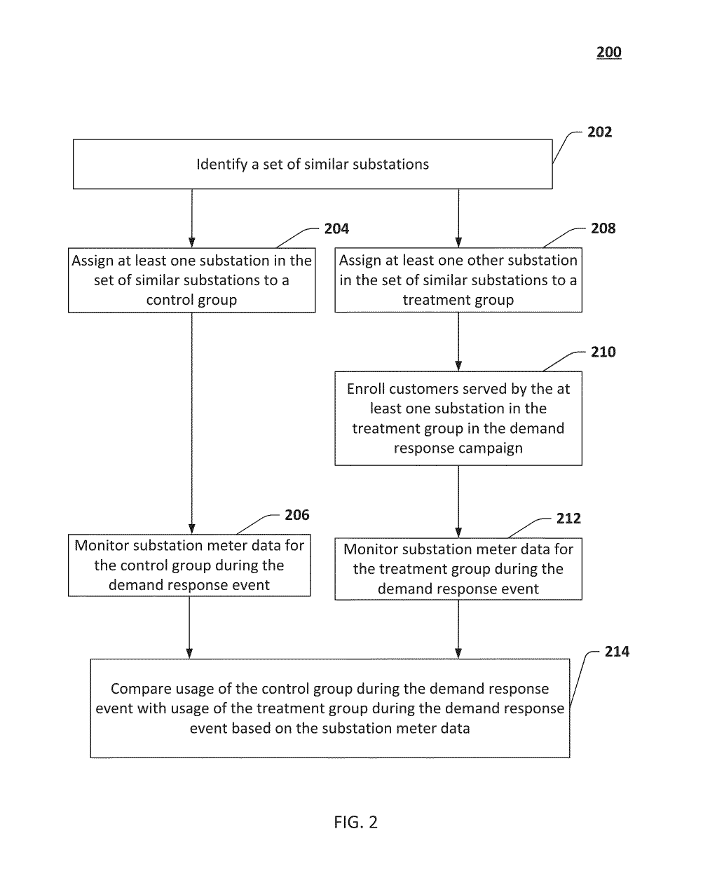

FIG. 2 illustrates an example process 200 for measuring the effectiveness of a demand response campaign by comparing usage information for a control substation and usage information for a similar treatment substation. The process 200 may be performed by the computing system 155 in FIG. 1.

At step 202, a set (e.g., two or more) of similar substations is identified. These substations may be identified based on substation characteristics such as similar load shape, similar usage amounts, similar territory size and location, and/or any other attributes that are predictive of load. Additional attributes may include composition of customers that the substation serves. The composition may include similar numbers or proportions of different categories of customers (e.g., commercial, industrial, residential customers, renter or owner, apartment, condo, townhome, single-family residence, etc.). In some embodiments, attributes may include average or median annual income, age, lot size, or number of late payments for the customers served or other measures of socio-economic variables. The substation characteristics may be received from a utility server, from each substation, and/or a third-party provider of such information.

At least one of the substations in the set is assigned to a control group at step 204 and at least one other substation in the set is assigned to a treatment group at step 208. In one implementation, the substations are assigned to the treatment group or the control group randomly. The randomization may be validated to ensure a balance between the treatment group and the control group across any/all variables predictive of load. The customers served by the at least one substation in the treatment group may then be enrolled in the demand response campaign being tested and sent campaign communication(s) at step 210. The identities of these customers may be provided, for example, by a utility database (e.g., the first database 145). In this example, the computing system 155 may send the communications to the computing devices (e.g., computing devices 150a-150k) of the customers in the treatment group. Examples of communications that may be sent as part of the demand response campaign are discussed below. In one aspect, the control group is not treated differently from the norm (e.g., the customers served by the at least one substation in the control group do not receive demand response communications and/or are not part of any other campaign). However, in some variations the control group may be enrolled a different campaign to measure differences between two campaigns.

The computing system 155 may then monitor substation meter data for the control group during a demand response event at step 206 and monitor the substation meter data for the treatment group during the demand response event at step 212. For example, the utility server 142 may receive meter data from the substations in the control and treatment groups, and store the meter data in the first database 145. The computing system 155 may then retrieve the meter data for the substations from the first database 145, and store the meter data in the second database 160 for monitoring by the computing system 155. The substation meter data for each substation includes usage information for the respective substation and may comprise usage readings for numerous time intervals covering the demand response event (and optionally, time periods before and after the demand response event). Each reading may indicate an amount of the resource (e.g., electricity) consumed by the aggregate of the customers served by the corresponding substation over a time interval (e.g., time interval of an hour or less). The demand response event may correspond to a peak event (e.g., a few hours of a hot day during which demand is high due to heavy air conditional loads).

Based on the substation meter data received from the two groups, the usage of the control group during the demand response event may be compared with the usage of the treatment group during the demand response event at step 214.

The computing system 155 may then determine the demand response performance of the treatment group (e.g., how much the treatment group outperformed the control group) based on the comparison. These differences may be reported to the utility company or a third-party in order to show the efficacy of the demand response campaign and/or to help design future demand response campaigns. For example, the computing system 155 may report the comparison to the utility server 142.

The process in FIG. 2 is shown as being performed on one set of similar substations as a simple illustrative example. In other implementations, the process may also be repeated for multiple sets of similar substations in order to generate additional data points for measuring the performance of a demand response campaign.

As discussed above, the computing system determines the demand response performance of the treatment group (and hence the efficacy of the demand response campaign) based on the usage data for the substations in the treatment group and the control group. This may be done using a variety of methods according to various embodiments of the subject technology.

In one embodiment, the computing system 155 may collect historical usage data for a substation in the treatment group corresponding to one or more previous days. For example, the computing system 155 may retrieve the historical usage data from the first database 145, and store the retrieved historical data in the second database 160 for use by the computing system 155. The one or more previous days may have similar weather patterns as the peak day (i.e., day on which the peak event occurs). For example, the one or more previous days may be in the same week, month or season (e.g., summer) as the peak day. For each of the one or more previous days, the computing system 155 may compute resource usage over a time period of that day corresponding to the time period of the peak event. For example, if the peak event occurs during the hours of 12 pm to 7 pm on the peak day, then the computing system 155 may compute the usage for the previous day over the hours of 12 pm to 7 pm based on the historical usage data. For the example in which the resource is electricity, usage may be expressed in terms of kilowatt hours (kWh). In one aspect, the one or more previous days may occur during days in which a demand response campaign was not implemented for the treatment group.

After resource usage is computed for each of the one or more previous days, the computing system 155 may compute an average of the resource usages to obtain a baseline resource usage for the peak event. If only one previous day is used, then the baseline resource usage may be the computed resource usage for that previous day. In this example, the baseline usage provides an estimate of the amount of resources that would have been used (consumed) by the substation in the treatment group during the peak event without the demand response campaign. Thus, the baseline resource usage provides a baseline for measuring the efficacy of the demand response campaign.

After the peak event, the computing system 155 may determine the actual resource usage for the substation in the treatment group during the peak event based on usage data received from the respective meter device. The computing system 155 may then compute the difference between the actual resource usage during the peak event and the baseline resource usage for the peak event. The difference may indicate the amount by which the customers served by the substation in the treatment group reduced usage in response to the demand response campaign. The effectiveness of the demand response campaign may be a function of the difference with a larger difference indicating a more effect demand response campaign. In one aspect, the difference may be expressed as a percentage by which the actual usage is lower than the baseline usage.

In this embodiment, the computing system 155 may also collect historical usage data for a substation in the control group corresponding to one or more previous days. For example, the computing system 155 may retrieve the historical usage data from the first database 145, and store the retrieved historical data in the second database 160 for use by the computing system 155. The one or more previous days may be the same as that used for the treatment group. For each of the one or more previous days, the computing system 155 may compute resource usage over a time period of that day corresponding to the time period of the peak event. For example, if the peak event occurs during the hours of 12 pm to 7 pm on the peak day, then the computing system 155 may compute the resource usage for the previous day over the hours of 12 pm to 7 pm based on the historical usage data. In one aspect, the one or more previous days may occur during days in which a demand response campaign was not implemented for the control group.

After resource usage is computed for each of the one or more previous days, the computing system 155 may compute an average of the resource usages to obtain a baseline resource usage for the control group for the peak event. If only one previous day is used, then the baseline resource usage may be the computed resource usage for that previous day. The baseline resource usage provides a prediction of the resource usage for the control group during the peak event.

After the peak event, the computing system 155 may determine the actual resource usage for the substation in the control group during the peak event based on usage data received from the respective meter device. The computing system 155 may then compute the difference between the actual resource usage for the control group during the peak event and the baseline resource usage for the control group for the peak event. The difference may indicate the accuracy with which the baseline predicts the actual resource usage for the control group during the peak event with a smaller difference indicating a more accurate baseline. In one aspect, the difference may be expressed as a percentage by which the actual usage is different from the baseline usage.

After the difference for the control group is computed, the difference for the control group may be subtracted from the difference for the treatment group. This may be done to adjust the difference for the treatment group to account for error in the baseline usage computed for the treatment group, assuming the baseline usage for the control group has a similar error. The error may be due to the fact that the weather patterns during the one or more previous days do not exactly match the weather pattern on the peak day and/or one or more other factors. The adjusted difference for the treatment group (i.e., initial difference for treatment group minus the difference for the control group) may be used to evaluate the effectiveness of the demand response campaign with a larger difference being indicative of a more effective campaign.

It is to be appreciated that the baseline usages for the treatment group and the control group may be determined using other methods, and therefore that the subject technology is not limited to the exemplary method discussed above. For example, in another embodiment, the baseline usage for the treatment group may be computed using a baseline model for the substation in the treatment group. The baseline model may predict a resource usage value for the substation over a short time interval (e.g., one hour or less) as a function of one or more variables (e.g., temperature, time of day, dew point, etc.) that influence usage. The resource usage value may represent the amount of resources used (consumed) by the customers served by the substation over the time interval. For the example in which the resource is electricity, the usage value may be expressed in terms of kilowatt hours (kWh) or other unit.

In this embodiment, the baseline model may be generated using historical usage data for the substation in the treatment group. The historical usage data may cover a period of time during which the customers served by the substation in the treatment group are not enrolled in a demand response campaign. The period of time may span one or more days, one or more weeks, one or more months, a season (e.g., summer), a year, etc. The historical usage data may comprise a plurality of usage values, where each usage value indicates the amount of resources used (consumed) by the customers served by the substation over a respective time interval (e.g., interval of an hour or less). Each usage value may correspond to a usage reading from the meter device of the substation, in which each usage reading indicates the usage measured by the meter device over the respective time interval.

For each usage value, the computing system may also collect one or more values for the one or more variables of the baseline model. For the example in which one of the variables is temperature, the computing system 155 may collect a temperature reading for each usage value. In this example, the temperature reading may be provided by a temperature sensor (not shown) located at or near the substation and/or provided by a weather service.

After the usage values and corresponding variable values (e.g., temperature values) are collected, the computing system 155 may generate the baseline model for the substation based on the usage values and the corresponding variable values. For example, the computing system 155 may generate the baseline model using linear regression, in which a linear function or piecewise linear function is fitted to the usage values and the corresponding variable values (e.g., using least squares fit). In another example, the computing system 155 may generate the baseline model by fitting another type of function to the usage values and the corresponding variable values.

After the baseline model is generated for the substation in the treatment group, the computing system 155 may compute the baseline usage for the substation in the treatment group for the peak event. To do this, the computing system 155 may partition the peak event (e.g., 12 pm to 7 pm on the peak day) into a plurality of time intervals (e.g., each time interval spanning an hour or less). For each time interval, the computing system 155 may collect one or more corresponding variable values. For the example in which one of the variables is temperature, the computing system 155 may collect a temperature value for each time interval. Each temperature value may be provided by a temperature sensor located at or near the substation and/or provided by a weather service, as discussed above. The computing system 155 may then compute a baseline usage value for each time interval by inputting the corresponding one or more variable values into the baseline model. The computing system 155 may then compute the baseline usage for the substation for the entire peak event by summing the usage values for the plurality of time intervals. The baseline usage provides an estimate of the amount of resources that would have been used (consumed) by the substation in the treatment group during the peak event without the demand response campaign. The computing system 155 may compute a difference between the baseline usage and the actual usage during the peak event to measure the efficacy of the demand response campaign, as discussed above.

The computing system 155 may also generate a baseline model for the substation in the control group in a manner similar to that used to generate the baseline model for the substation in the treatment group. The computing system 155 may then compute the baseline usage for the substation for the peak event using the baseline model. The computing system 155 may also compute a difference between the baseline usage for the substation in the control group and the actual usage for the substation in the control group during the peak event. The difference for the control group provides an indication of the accuracy of the baseline model, and should be close to zero if the baseline model is accurate. The difference for the control group may then be subtracted from the difference for the treatment group to adjust the difference for the treatment group. This adjustment corrects for an error in the baseline model for the treatment group, assuming that the baseline model for the control group has a similar error. The errors for both baseline models may be due, for example, to an unaccounted for variable that has an effect on usage. The adjusted difference for the treatment group may then be evaluated to measure the efficacy of the campaign with a larger difference corresponding to a more effective campaign.

In yet another example, the efficacy of the demand response campaign may be measured by comparing the actual usage of the treatment group during the peak event with the actual usage of the control group during the peak event. In this example, the efficacy of the campaign may be measured based on how much the usage of the treatment group is lower than the usage of the control group. To account for a possible difference in the numbers of customers served by the substations in the treatment and control groups, the actual usage for one or both groups may be normalized to account for this difference. This may be done for example by dividing the actual usage for each substation by the number of customers served by the substation. In one example, the substations in the treatment and control groups may be chosen to have approximately the same number of customers to minimize this difference (e.g., customer size may a criterion for determining whether two substations are similar).

The exemplary methods discussed above were described above using the example of one substation in the treatment group and one substation in the control group for ease of discussion. However, it is to be appreciated that these methods are not limited to this example. For instance, the computing system 155 may measure the efficacy of the demand response campaign using two or more substations in each group. In this case, the computing system 155 may compute the baseline usage for the treatment group by computing a baseline usage for each substation in the treatment group using any of the methods discussed above, and summing the computed baseline usages to obtain the baseline usage for the treatment group. The computing system 155 may also compute actual usage for the treatment group by determining the actual usage for each substation in the treatment group during the peak event (e.g., based on meter data from the respective meter device), and summing the actual usages to obtain the actual usage for the treatment group. Similarly, the computing system 155 may compute the baseline usage for the control group by computing a baseline usage for each substation in the control group using any of the methods discussed above, and summing the computed baseline usages to obtain the baseline usage for the control group. The computing system 155 may also compute actual usage for the control group by determining the actual usage for each substation in the control group during the peak event (e.g., based on meter data from the respective meter device), and summing the actual usages to obtain the actual usage for the control group.

As discussed above, the process in FIG. 2 is shown as being performed on one set of similar substations as a simple illustrative example. In other implementations, the process may also be performed using two or more sets of similar substations, as discussed further below.

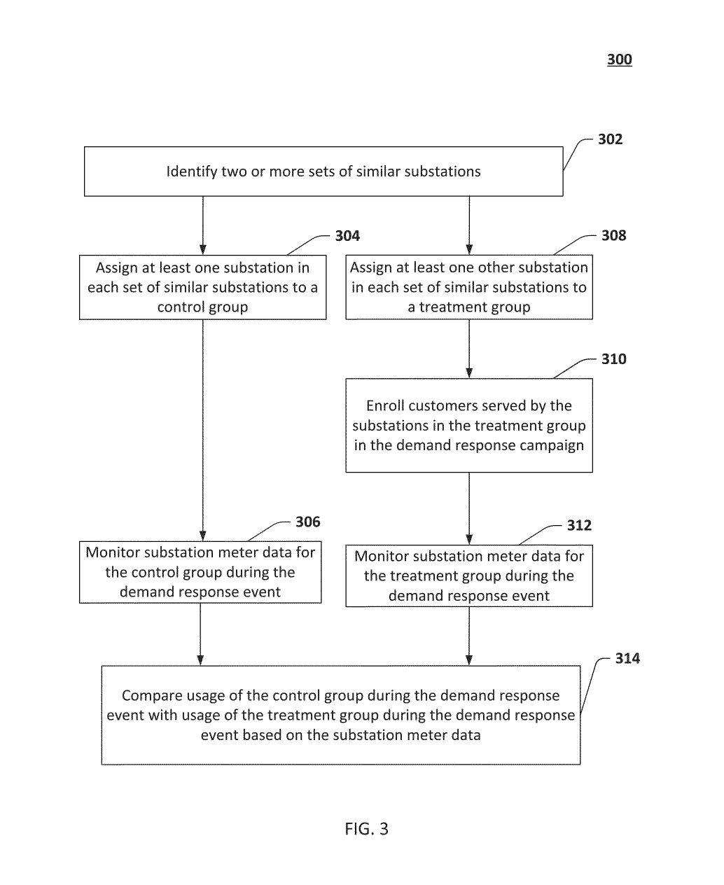

FIG. 3 illustrates an example process 300 for measuring the efficacy of a demand response campaign using more than one set of similar substations. The process 300 may be performed by the computing system 155 in FIG. 1.

At step 302, two or more sets of similar substations are identified. For example, the computing system 155 may analyze attributes of a plurality of substations (e.g., substations in an electric distribution network) to determine sets of similar substations. The attributes may include load shape, territory size and location, and/or any other attributes that are predictive of load. Additional attributes may include composition of customers that a substation serves. The composition may include similar numbers or proportions of different categories of customers (e.g., commercial, industrial and/or residential customers). Based on the analysis, the computing system 155 may assign substations with similar attributes to the same set. Each substation in a particular set of substations may be similar to other substations in the set, but not necessarily similar to other substations in a different set of substations. In other words, substations in the same set are similar while substations in different sets may not be similar.

At step 304, at least one substation in each set of similar substations is assigned to a control group and at least one other substation in each set of similar substations is assigned to a treatment group at step 308. In other words, for each set of similar substations, at least one substation in the set is assigned to the control group and at least one other substation in the set is assigned to the treatment group. This helps ensure that the control group and the treatment group are statistically equivalent.

The customers served by the substations in the treatment group may then be enrolled in the demand response campaign being tested and sent campaign communication(s) at step 310. The identities of these customers may be provided, for example, by a utility database (e.g., the first database 145). In this example, the computing system 155 may send the communications to the computing devices (e.g., computing devices 150a-150k) of the customers in the treatment group. In one aspect, the control group is not treated differently from the norm (e.g., the customers served by the substations in the control group do not receive demand response communications and/or are not part of any other campaign). However, in some variations the control group may be enrolled a different campaign to measure differences between two campaigns.

The computing system 155 may then monitor substation meter data for the control group during a demand response event at step 306 and monitor the substation meter data for the treatment group during the demand response event at step 312. For example, the utility server 142 may receive meter data for the substations in the control and treatment groups, and store the meter data in the first database 145. The computing system 155 may then retrieve the meter data from the first database 145, and store the meter data in the second database 160 for monitoring by the computing system 155. The substation meter data for each substation includes usage information for the respective substation and may comprise usage readings for numerous time intervals covering the demand response event (and optionally, time periods before and after the demand response event). Each reading may indicate an amount of the resource (e.g., electricity) consumed by the aggregate of the customers served by the corresponding substation over a time interval (e.g., time interval of an hour or less). The demand response event may correspond to a peak event (e.g., a few hours of a hot day during which demand is high due to heavy air conditional loads).

Based on the substation meter data received from the two groups, the usage of the control group during the demand response event may be compared with the usage of the treatment group during the demand response event at step 314.

The computing system 155 may then determine the demand response performance of the treatment group (e.g., how much the treatment group outperformed the control group) based on the comparison. These differences may be reported to the utility company or a third-party in order to show the efficacy of the demand response campaign and/or to help design future demand response campaigns.

For example, the computing system 155 may compute a baseline usage for the treatment group by computing a baseline usage for each substation in the treatment group using any of the methods discussed above, and summing the computed baseline usages to obtain the baseline usage for the treatment group. The computing system 155 may also compute actual usage for the treatment group by determining the actual usage for each substation in the treatment group during the peak event (e.g., based on meter data from the respective meter device), and summing the actual usages to obtain the actual usage for the treatment group. The computing system 155 may then compute a difference between the baseline usage for the treatment group and the actual usage for the treatment group. The difference may be expressed as a percentage by which the actual usage is lower than the baseline usage.

The computing system 155 may also compute a baseline usage for the control group by computing a baseline usage for each substation in the control group using any of the methods discussed above, and summing the computed baseline usages to obtain the baseline usage for the control group. The computing system 155 may further compute actual usage for the control group by determining the actual usage for each substation in the treatment group during the peak event (e.g., based on meter data from the respective meter device), and summing the actual usages to obtain the actual usage for the control group. The computing device 155 may then compute a difference between the baseline usage for the control group and the actual usage for the control group, and subtract the difference for the control group from the difference for the treatment group to adjust the difference for the treatment group. The adjusted difference for the treatment group may then be used to evaluate the efficacy of the demand response campaign with a larger adjusted difference being indicative of a more effective campaign.

In yet another example, the computing system 155 may measure the efficacy of the demand response campaign by comparing the actual usage of the treatment group during the peak event with the actual usage of the control substation during the peak event, as discussed above.

As discussed above, a demand response campaign or program involves sending communications (pre-event notifications) to utility customers (e.g., via electronic mail, regular mail, etc.) enrolled in the campaign before the peak event. The communications may be sent one or more days before the peak event (or even a few hours before the peak event) via e-mails, text messages, automated calls, or any combination thereof. For example, the computing system 155 may send the communications to the computing devices 150a-150k of the customers via the network 140 in the form of e-mails, text messages, etc. Each communication may inform the respective customer of the upcoming peak event and ask the customer to reduce usage during the peak event. For example, the communication may also identify the day and time period (e.g., 2 pm-7 pm) of the event, and include recommendations for reducing energy consumption during the peak event such as setting a thermostat a few degrees higher, shifting use of large appliances (e.g., dishwasher) to non-peak hours, etc. If utility rates will be higher during the peak event, then the communication may also inform the customer of the higher rates to encourage the customer to reduce usage during the peak event. If the utility offers a rebate to the customer based on the amount of energy the customer saves during the peak event, then the communication may also inform the customer of the rebate.

After the peak event, the computing system 155 may send each customer a post-event notification providing the customer with feedback on how much energy he/she saved during the peak event. For example, the computing system 155 may send the post-event notification to the computing device of the customer via the network 140 in the form of an e-mail, a text message, etc. For example, if AMI data is available at the customer level, then the post-event notification may indicate the amount of the resource (e.g., electricity) that the customer saved during the peak event. In this example, the post-event notification may also compare the customer's energy savings with the energy savings of one or more other customers.

Thus, a customer's demand response performance may be computed using meter data from the customer's meter device (e.g., smart meter) for the case where AMI data is available at the customer level. This information may be used to compute how much of the resource (e.g., electricity) the customer has saved during the peak event, to compare the customer's performance for a peak event with the customer's performance during one or more other peak events, and/or to compare the customer's performance for a peak event with another customer's performance (or other customers' performance) for the peak event. However, customer level comparisons may be difficult for cases where AMI data is not available at the customer level. This is because, without smart meter data for an individual customer, it may be difficult to accurately measure the usage for the individual customer during a peak event.

To address this, embodiments of the subject technology determine demand response performance at a neighborhood level, in which a neighborhood corresponds to an aggregate of the customers served by a substation. The performance of each neighborhood is determined based on meter data received from the corresponding substation during a demand response event, as discussed further below. This allows the computing system to compare the performance one of neighborhood with the performance of another similar neighborhood. Insights that are generated from the comparison may be sent to customers of the substations in order to inform the customers and encourage better performance in future demand response events.

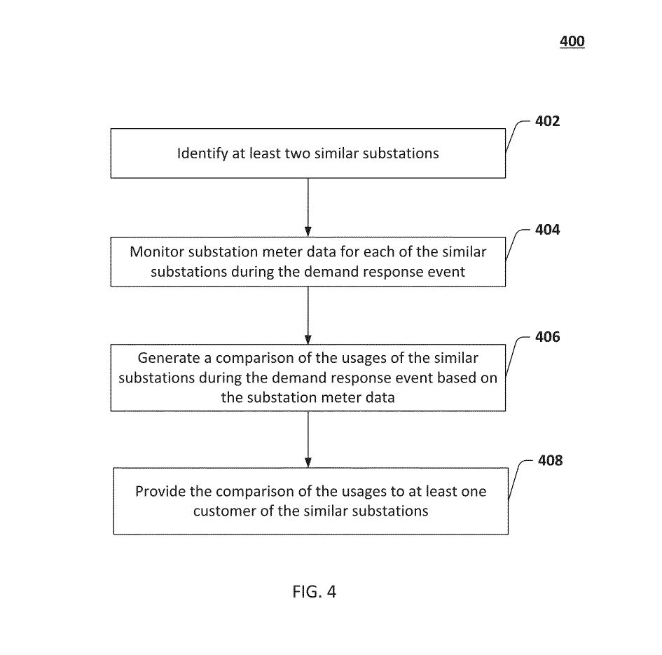

Because each substation typically serves a bounded geographic location, the customers served by the substation may be collectively thought of as a “neighborhood.” Accordingly, comparative information may be provided to utility customers to show their neighborhood performance relative to the performance of other neighborhoods. In this regard, FIG. 4 illustrates an exemplary process 400 for determining the demand response performance one neighborhood (customers served by a substation) compared with the demand response performance of at least one other neighborhood (customers served by at least one other substation). The process 400 may be performed by the computing system 155.

As shown in FIG. 4, the computer system 155 may first identify at least two similar substations at step 402. As described above, similar substations may be identified based on substation characteristics such as customer composition, similar load shape, similar territory size and location, and/or any other attributes that are predictive of load. The customers in the similar substations may be enrolled in a demand response campaign.

At step 404, the computing system 155 may then monitor substation meter data for the similar substations during a demand response event. The substation meter data for each substation may be received from the corresponding meter device and may include usage information for the substation. For example, the utility server 142 may receive the meter data for each substation, and store the meter data in the first database 145. The computing system 155 may then retrieve the meter data from the first database 145, and store the meter data in the second database 160 for monitoring by the computing system 155. The usage information may comprise readings for numerous time intervals that cover one or more time periods corresponding to the demand response event (and optionally, time periods before and after the demand response event).

Based on the substation meter data, the computing system 155 at step 406 may generate a comparison of the usages of the similar substations during the demand response event. The comparison may include a juxtaposition of the amounts of energy used or saved by customers of the similar substations during the demand response event or a qualitative determination that customers of one substation used less energy or saved more energy than customers of another similar substation. Additional examples of the many different comparisons that may be generated are discussed further below. For example, the system may also identify “energy efficient neighbors” and compare the amount of energy used or saved by customers of one substation with the amount of energy used or saved by customers of an energy efficient substation.

At step 408, the comparison may be provided to one or more customers of the similar substations in order to inform customers, and encourage participation and improved performance in future demand response campaigns.

In one embodiment, the computing system 155 may compute usage for a substation during a peak event. To do this, the computing system 155 may receive meter data for the respective meter device. The meter data may comprise usage values or readings, in which each usage value provides the amount of the resource used (consumed) by the customers served by the substation over a short time interval. In this example, the computing system 155 may compute the usage during the peak event by summing the usage values having time intervals within the peak event. The computing system 155 may compute usage for each one of the other substations during the peak event by repeating the above method for each substation.

After computing the usage for each of the similar substations, the computing system 155 may compare the usage for a particular substation with the usage of one or more other similar substations and send the comparison to customers served by that particular substation. For example, the computing system 155 may compute an average usage across a plurality of similar substations or all similar substations. The computing system 155 may then compare the average usage with the usage for a particular substation, and send the comparison to customers served by that particular substation. For example, the computing system 155 may send the comparison to each of these customers by including the comparison in the post-event notification for each customer. The comparison shows these customers how their neighborhood performed relative to other neighborhoods. In this example, the comparison may show the usage of the customers' substation (e.g., identified as usage for “your neighborhood”) and show the average usage for the other similar substations (e.g., identified as usage for “other neighborhoods”). The comparison may also be expressed as a percentage by which the usage of the customers' substation is less than or greater than the usage of the average usage of the other neighborhoods.

In another example, the computing system 155 may rank the similar substations based on their usages during the peak event. For example, the computing system 155 may rank the similar substations from the substation with the lowest usage to the substation with the highest usage. For each substation, the computing system 155 may send the rank of the substation to the customers served by the substation. For example, the computing system 155 may send the rank to each of these customers by including the rank in the post-event notification for each customer. Each post-event notification may identify the rank as the rank for “your neighborhood” compared with “other neighborhoods.”

In yet another example, the computing system 155 may identify an efficient neighborhood based on the usages for the similar substation. For instance, the computing system 155 may identify a neighborhood as the most efficient neighborhood if the corresponding substation has the lowest usage. In another example, the computing system 155 may identify a neighborhood as efficient if the usage for the corresponding substation is lower than the usages for a certain percentage of the other similar substations (e.g., lower than 90% of the other substations). After identifying the efficient neighborhood, the computing system 155 may then compare the usage for the efficient neighborhood with the usage for a particular substation, and send the comparison to customers served by that particular substation. For example, the computing system 155 may send the comparison to each of these customers by including the comparison in the post-event notification for each customer. The comparison shows these customers how their neighborhood performed relative to the efficient neighborhood. In this example, the comparison may show the usage of the customers' substation (e.g., identified as usage of “your neighborhood”) and show the usage of the efficient neighborhood (e.g., identified as usage of “efficient neighborhood”). The comparison may also be expressed as a percentage (e.g., 10%) by which the usage of the customers' substation is greater than the usage of the efficient neighborhood.

In one embodiment, the computing system 155 may normalize the usages for the similar substations to account for a possible variation in the number of customers served by each substation. This may be done, for example, by simply dividing the usage for each substation by the number of customers served by the substation or other method. The normalized usages may then be used in any of the comparisons discussed above.

For each substation, the computing system 155 may compute an amount of the resource (e.g., electricity) saved during the current peak event. The computing system 155 may do this, for example, by subtracting the actual usage for the substation during current peak event from a baseline usage. The amount saved may be in the form of a percentage by which the usage for the current peak event is less than the baseline usage.

The baseline usage for a substation may be determined using any one of a variety of methods. For example, the baseline usage may be the usage for the substation during a time period of a previous day, in which the time period (e.g., 2 pm-7 pm) of the previous day may correspond to the time period of the peak event (e.g., 2 pm-7 pm). In this example, the computing system 155 may compute the usage for the previous day using meter data received for the respective meter device on the previous day. The previous day may correspond to a previous peak day or a non-peak day.

In another example, the computing system 155 may compute usage for the substation during the time period (e.g., 2 pm-7 pm) for each one of a plurality of previous days, and compute the average of the computed usages for the baseline usage. In this example, the computing system 155 may compute the usage for each of the previous days using meter data received for the respective meter device. One or more of the previous days may correspond to a previous peak day.

In yet another embodiment, the computing system 155 may determine the baseline usage for the substation using a baseline model of the substation, as discussed above. The baseline model may be generated using historical usage data for the substation covering peak days, non-peak days, or a combination of peak and non-peak days.

After computing the amount of the resource saved by each substation during the current peak event, the computing system 155 may compare the amount saved for a particular substation with the amount saved for one or more other similar substations and send the comparison to customers served by that particular substation. For example, the computing system 155 may compute an average of the amount saved across a plurality of similar substations or all of the similar substations. The computing system 155 may then compare the average amount saved with the amount saved for a particular substation, and send the comparison to customers served by that particular substation. For example, the computing system 155 may send the comparison to each of these customers by including the comparison in the post-event notification for each customer. The comparison shows these customers how much energy their neighborhood saved during the peak event relative to other neighborhoods. In this example, the comparison may show the amount saved by the customers' substation (e.g., identified as amount saved by “your neighborhood”) and show the average amount saved for the other similar substations (e.g., identified as amount saved by “other neighborhoods”).

In another example, the computing system 155 may rank the similar substations based on amounts saved by the similar substations during the peak event. For example, the computing system 155 may rank the similar substations from the substation with the largest amount saved to the substation with the lowest amount saved. For each substation, the computing system 155 may send the rank of the substation to the customers served by the substation. For example, the computing system 155 may send the rank to each of these customers by including the rank in the post-event notification for each customer. Each post-event notification may identify the rank as the rank for “your neighborhood” compared with “other neighborhoods.” The post-event notification may also indicate the number of similar substations to add context to the rank.

In yet another example, the computing system 155 may identify an efficient neighborhood based on the amounts saved for the similar substations. For instance, the computing system 155 may identify a neighborhood as the most efficient neighborhood if the amount saved by the corresponding substation is the highest among the similar substations. In another example, the computing system 155 may identify a neighborhood as efficient if the amount saved by the corresponding substation is higher than the amounts saved by a certain percentage of the other similar substations (e.g., lower than 90% of the other substations). After identifying the efficient neighborhood, the computing system 155 may then compare the amount saved by the efficient neighborhood with the amount saved by a particular substation, and send the comparison to customers served by that particular substation. For example, the computing system 155 may send the comparison to each of these customers by including the comparison in post-event notification for each customer. The comparison shows these customers how much energy their neighborhood saved during the peak event relative to the efficient neighborhood. In this example, the comparison may show the amount saved by the customers' substation (e.g., identified as amount saved by “your neighborhood”) and show the amount saved by the efficient neighborhood (e.g., identified as amount saved by “efficient neighborhood”).

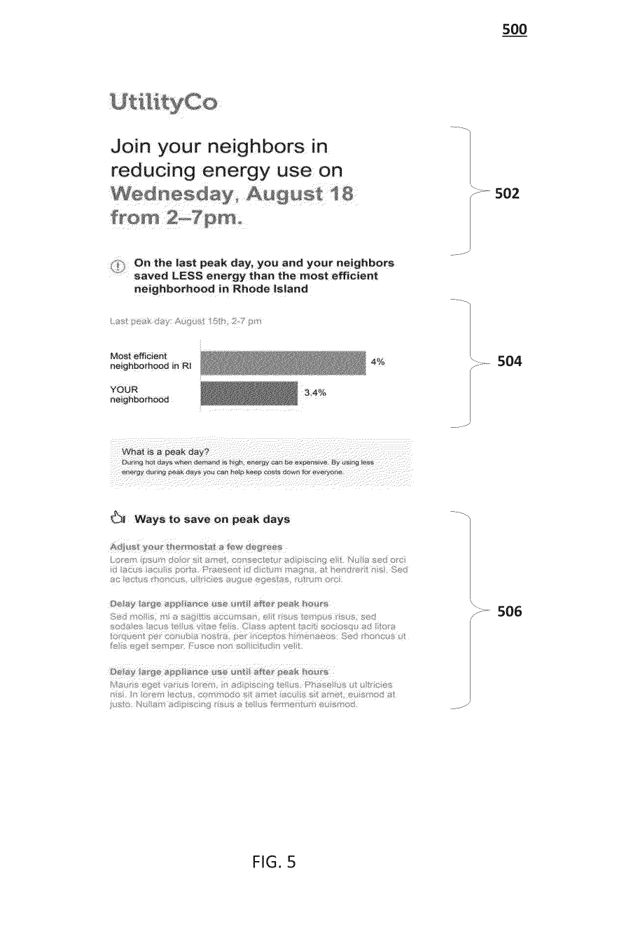

FIG. 5 illustrates an example pre-event notification 500 that may be sent to a customer via electronic mail. The pre-event notification includes a message 502 identifying a day and time period for an upcoming peak event, and a message 506 providing tips for reducing energy use during the peak event. The pre-event notification 500 also includes a comparison 504 of the performance of the customer's neighborhood during the last peak event relative to the performance of the most efficient neighborhood during the last peak event. The comparison 504 of the performance of the customer's neighborhood during the last peak event informs the customer about the neighborhood's past performance in a previous peak event and potentially motivates the customer to maintain or improve upon the customer's past performance in the upcoming peak event.

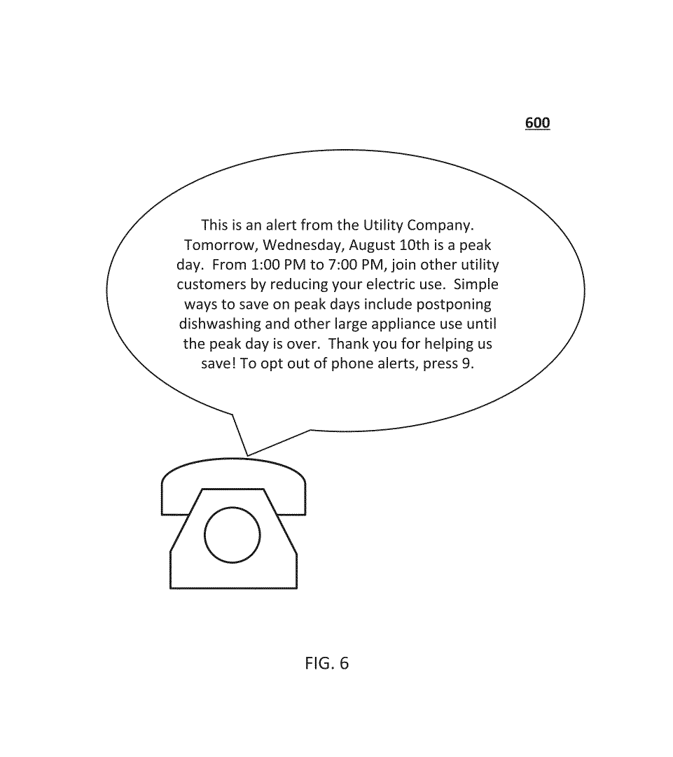

FIG. 6 illustrates an example pre-event notification 600 that may be sent to a customer via interactive voice response (IVR). The notification 600 audibly informs the customer of an upcoming peak event and provides tips for reducing energy use during the peak event.

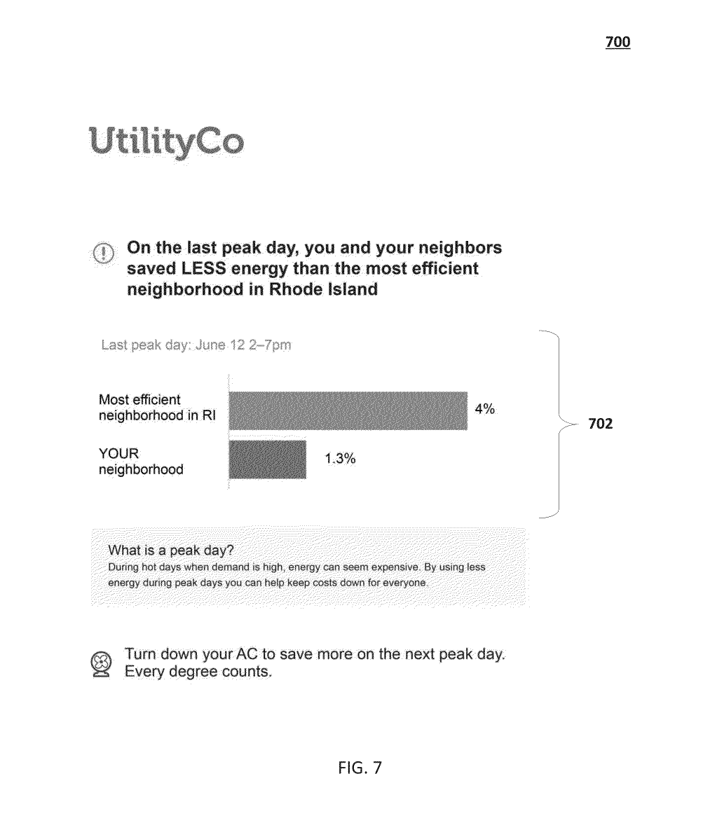

FIG. 7 illustrates an example post-event notification 700 that may be sent to a customer via electronic mail. The post-event notification 700 also includes a comparison 702 of the performance of the customer's neighborhood during the peak event relative to the performance of the most efficient neighborhood during the peak event. In the example shown in FIG. 7, the performance for each neighborhood is expressed as a percentage of the energy saved during the peak event.

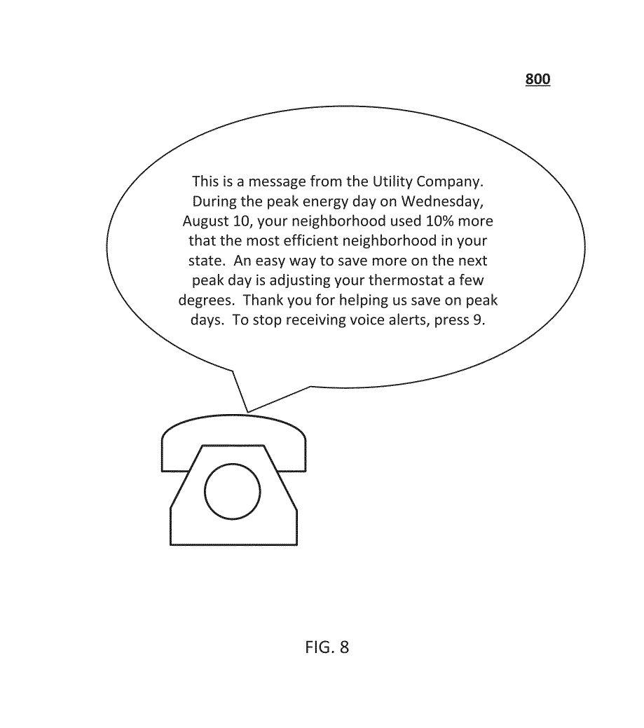

FIG. 8 illustrates an example post-event notification 800 that may be sent to a customer via interactive voice response (IVR). The notification 800 audibly informs the customer of the performance of the customer's neighborhood during the peak event relative to the performance of the most efficient neighborhood during the peak event. In the example shown in FIG. 8, the performance for each neighborhood is expressed as a percentage by which the energy use of the customer's neighborhood exceeded the use of the most efficient neighborhood.

It is appreciated that other types of communications may be provided and still be within the scope of the subject technology. For example, SMS messages (e.g., text messages), MMS messages, instant messages, among other types of messages or communications, etc., may be provided.

Thus, the subject technology provides at least two applications of substation meter data related to demand response. In one application, substation meter data may be used to assess the efficacy of a demand response campaign. In another application, substation meter data may be used to provide neighborhood-level comparisons. The aforementioned applications may be applied independently or in combination, and the steps used to perform these applications may be ordered in many different ways.

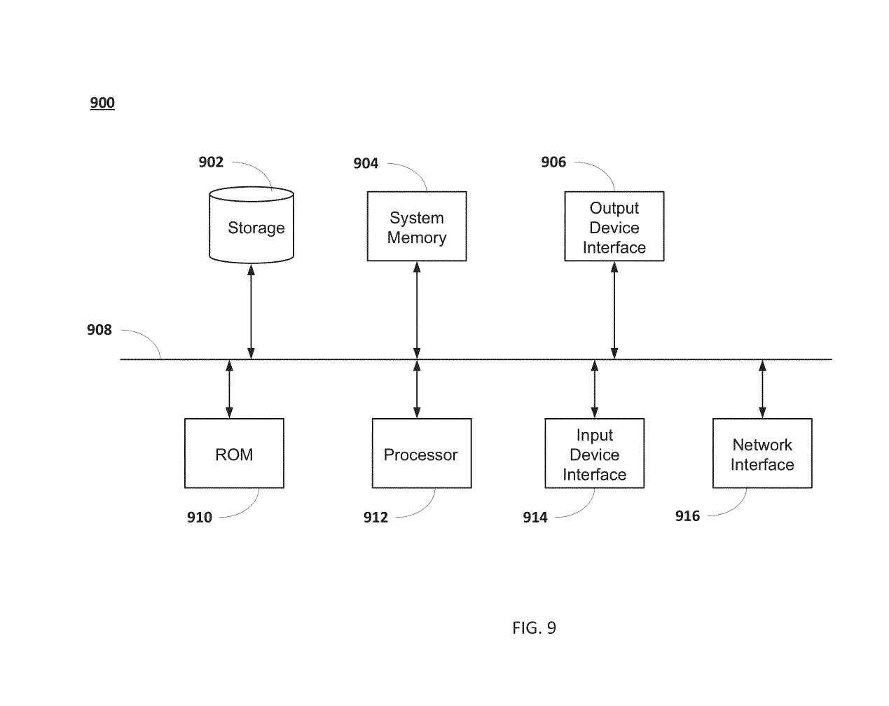

FIG. 9 illustrates an electronic system 900 with which features of the subject technology may be implemented. For example, electronic system 900 may be used to implement the computing system 155 in FIG. 1. Electronic system 900 may include a bus 908, processing unit(s) 912, a system memory 904, a read-only memory (ROM) 910, a permanent storage device 902, an input device interface 914, an output device interface 906, and a network interface 916.

Bus 908 collectively represents all system, peripheral, and chipset buses that communicatively connect the numerous internal devices of electronic system 900. For instance, bus 908 communicatively connects processing unit(s) 912 with ROM 910, system memory 904, and permanent storage device 902.

From these various memory units, processing unit(s) 912 may retrieve instructions (e.g., code) to execute and data to process in order to execute processes of the subject disclosure. For example, processing unit(s) 912 may retrieve instructions for performing processes 200, 300 or 400 discussed above. Processing unit(s) can be a single processor or a multi-core processor in different implementations.

ROM 910 stores static data and instructions that are needed by processing unit(s) 912 and other modules of the electronic system. Permanent storage device 902, on the other hand, is a read-and-write memory device. This device is a non-volatile memory unit that stores instructions and data even when electronic system 900 is off. Some implementations of the subject disclosure use a mass-storage device (such as a magnetic or optical disk and its corresponding disk drive) as permanent storage device 902. Other implementations use a removable storage device (such as a floppy disk, flash drive, and its corresponding disk drive) as permanent storage device 902. Like permanent storage device 902, system memory 904 is a read-and-write memory device. However, unlike storage device 902, system memory 904 is a volatile read-and-write memory, such a random access memory. System memory 904 stores some of the instructions and data that the processor needs at runtime. From these various memory units, processing unit(s) 912 may retrieve instructions to execute and data to process in order to execute the processes of some implementations.

Bus 908 also connects to input and output device interfaces 914 and 906. Input device interface 914 enables a user to communicate information and select commands to the electronic system. Input devices used with input device interface 914 include, for example, alphanumeric keyboards and pointing devices (also called “cursor control devices”). Output device interfaces 906 enables, for example, the display of images generated by the electronic system 900. Output devices used with output device interface 906 may include, for example, printers and display devices, such as cathode ray tubes (CRT) or liquid crystal displays (LCD).

Finally, as shown in FIG. 9, bus 908 also couples electronic system 900 to a network through a network interface 916. In this manner, the electronic system 900 can be a part of a network of computers (such as a local area network (“LAN”), a wide area network (“WAN”), or an Intranet, or a network of networks, such as the Internet. Any or all components of electronic system 900 can be used in conjunction with the subject disclosure. For example, the network interface 916 may be used to receive meter data from the meter device of a substation, to receive meter data for a substation from the utility serve 142 and/or first database 145, and/or to send pre-event and post-event notifications to a device of a customer (e.g., customer's mobile device). The data may be stored in the storage device 902 and/or system memory 904 for processing by processing units(s) 912. Processing unit(s) 912 may process the meter data from one or more substations to measure the efficacy of a demand response campaign and/or generate a neighborhood-level comparison.

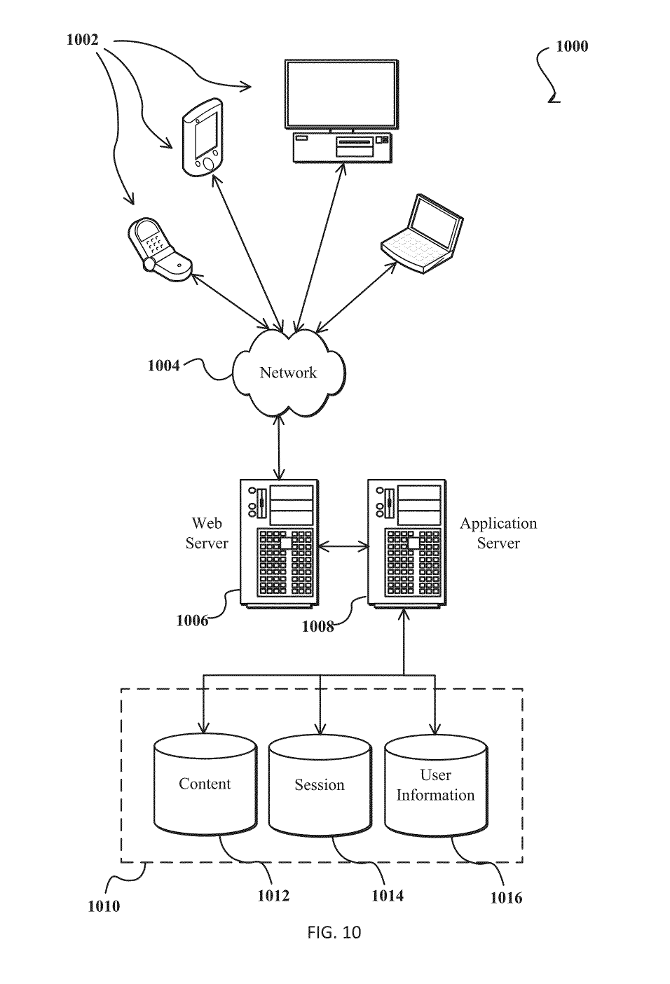

As discussed, different approaches can be implemented in various environments in accordance with the described embodiments. For example, FIG. 10 illustrates an example of an environment 1000 for implementing aspects of the subject technology in accordance with various embodiments. As will be appreciated, although a Web-based environment is used for purposes of explanation, different environments may be used, as appropriate, to implement various embodiments. The system includes an electronic client device 1002, which can include any appropriate device operable to send and receive requests, messages or information over an appropriate network 1004 and convey information back to a user of the device. Examples of such client devices include personal computers, cell phones, handheld messaging devices, laptop computers, set-top boxes, personal data assistants, electronic book readers and the like. The client device 1002 may be used to implement one of the computing devices 150 shown in FIG. 1.

The network 1004 can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 1006 for receiving requests and serving content in response thereto, although for other networks, an alternative device serving a similar purpose could be used, as would be apparent to one of ordinary skill in the art. The network 1004 may correspond to the network 140 in FIG. 1.

The illustrative environment includes at least one application server 1008 and a data store 1010. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server 1008 can include any appropriate hardware and software for integrating with the data store 1010 as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server 1006 in the form of HTML, XML or another appropriate structured language in this example. The handling of all requests and responses, as well as the delivery of content between the client device 1002 and the application server 1008, can be handled by the Web server 1006. It should be understood that the Web and application servers are not required and are merely example components, as structured code discussed herein can be executed on any appropriate device or host machine as discussed elsewhere herein.

The data store 1010 can include several separate data tables, databases or other data storage mechanisms and media for storing data relating to a particular aspect. For example, the data store illustrated includes mechanisms for storing content (e.g., production data) 1012 and user information 1016, which can be used to serve content for the production side. The data store is also shown to include a mechanism for storing log or session data 1014. It should be understood that there can be many other aspects that may need to be stored in the data store, such as page image information and access rights information, which can be stored in any of the above listed mechanisms as appropriate or in additional mechanisms in the data store 1010. The data store 1010 is operable, through logic associated therewith, to receive instructions from the application server 1008 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 1002. Information for a particular item of interest can be viewed in a dedicated page or window of the browser.

For example, the data store may include a pre-event notification for the user associated with a demand response campaign. In this example, the pre-event notification may be included on a Web page that the user is able to view on the browser on the user device. In another example, the data store may include a post-event notification for the user after the peak event. The post-event notification may be included on another Web page that the user can view on the user device after the peak event.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 10. Thus, the depiction of the system 1000 in FIG. 10 should be taken as being illustrative in nature and not limiting to the scope of the disclosure.

As discussed above, the various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”). Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and other non-transitory computer readable media for containing code, or portions of code, can include any appropriate storage media used in the art, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The description of the subject technology is provided to enable any person skilled in the art to practice the various embodiments described herein. While the subject technology has been particularly described with reference to the various figures and embodiments, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these embodiments will be readily apparent to those skilled in the art, and generic principles defined herein may be applied to other embodiments. Thus, many changes and modifications may be made to the subject technology, by one having ordinary skill in the art, without departing from the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various embodiments described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A computer-implemented method, comprising:
receiving first meter data for at least one substation in a treatment group during a demand response event, wherein a plurality of customers served by the at least one substation receive communications associated with a campaign for the demand response event;
receiving second meter data for at least one substation in a control group during the demand response event; and
measuring efficacy of the campaign based at least in part on the first meter data and the second meter data.

2. The method of claim 1, further comprising identifying a set of similar substations from a plurality of substations, wherein the at least one substation in the treatment group and the at least one substation in the control group are taken from the set of similar substations.

3. The method of claim 2, wherein identifying the set of similar substations is based on at least one attribute of each of the plurality of substations that is predictive of a load of the substation.

4. The method of claim 3, wherein the at least one attribute of each of the plurality of substations comprises at least one of a load shape of the substation, a territory size of the substation, a location of the substation, and composition of customers served by the substation.

5. The method of claim 1, wherein the communications comprise pre-event notifications, and each of the pre-event notifications notifies a respective one of the plurality of customers of the demand response event.

6. The method of claim 1, wherein measuring the efficacy of the campaign comprises:
determining an actual usage for the at least one substation in the treatment group during the demand response event based on the first meter data;
determining an actual usage for the at least one substation in the control group during the demand response event based on the second meter data; and
comparing the actual usage for the at least one substation in the treatment group with the actual usage for the at least one substation in the control group.

7. The method of claim 1, wherein measuring the efficacy of the campaign comprises:
determining an actual usage for the at least one substation in the treatment group during the demand response event based on the first meter data;
determining a baseline usage for the at least one substation in the treatment group based on historical meter data for the at least one substation in the treatment group; and
determining a first difference between the baseline usage for the at least one substation in the treatment group and the actual usage for the at least one substation in the treatment group.

8. The method of claim 7, wherein measuring the efficacy of the campaign comprises:
determining an actual usage for the at least one substation in the control group during the demand response event based on the second meter data;
determining a baseline usage for the at least one substation in the control group based on historical meter data for the at least one substation in the control group; and
determining a second difference between the baseline usage for the at least one substation in the control group and the actual usage for the at least one substation in the control group.

9. The method of claim 8, wherein measuring the efficacy of the campaign comprises determining a difference between the first difference and the second difference.

10. The method of claim 7, wherein the historical meter data corresponds to a period of time prior to the demand response event.

11. A system, comprising:
a computer processor; and
a memory storing instructions that, when executed by the computer processor, cause the computer processor to:
receive first meter data for at least one substation in a treatment group during a demand response event, wherein a plurality of customers served by the at least one substation receive communications associated with a campaign for the demand response event;
receive second meter data for at least one substation in a control group during the demand response event; and
measure efficacy of the campaign based at least in part on the first meter data and the second meter data.

12. A non-transitory computer-readable medium storing instructions that, when executed by a computer processor, cause the computer processor to:
receive first meter data for at least one substation in a treatment group during a demand response event, wherein a plurality of customers served by the at least one substation receive communications associated with a campaign for the demand response event;
receive second meter data for at least one substation in a control group during the demand response event; and
measure efficacy of the campaign based at least in part on the first meter data and the second meter data.

13. A computer-implemented method, comprising:
identifying at least two similar substations;
receiving meter data for each one of the similar substations during a demand response event;
generating a comparison of usages of the similar substations during the demand response event based at least in part on the meter data for the similar substations; and
providing the comparison to at least one customer of the similar substations.

14. The method of claim 13, wherein the at least two similar substations are identified from a plurality of substation, and wherein identifying the at least two similar substations is based on at least one attribute of each of the plurality of substations that is predictive of a load of the substation.

15. The method of claim 14, wherein the at least one attribute of each of the plurality of substations comprises at least one of a load shape of the substation, a territory size of the substation, a location of the substation, and composition of customers served by the substation.

16. The method of claim 13, wherein generating the comparison comprises:
determining usage of a first one of the similar substations based on meter data for the first one of the similar substations;
determining usage of a second one of the similar substations based on meter data for the second one of the similar substations; and
comparing the usage of the first one of the similar substations with the usage of the second one of the similar substations, wherein the at least one customer is served by the first one of the similar substations.

17. The method of claim 13, wherein generating the comparison comprises:
determining usage of a first one of the similar substations based on meter data for the first one of the similar substations;
determining average usage of a plurality of the similar substations based on meter data for the plurality of the similar substations; and
comparing the usage of the first one of the similar substations with the average usage of the plurality of the similar substations, wherein the at least one customer is served by the first one of the similar substations.

18. The method of claim 13, wherein generating the comparison comprises:
determining usage of a first one of the similar substations based on meter data for the first one of the similar substations;
identifying an efficient one of the similar substations;
determining usage of the efficient one of the similar substations based on meter data for the efficient one of the similar substations; and
comparing the usage of the first one of the similar substations with the usage of the efficient one of the similar substations, wherein the at least one customer is served by the first one of the similar substations.

19. The method of claim 18, wherein identifying the efficient one of the similar substations comprises:
determining usage of each of the similar substations based on meter data for the similar substation; and
identifying one of the similar substations having a lowest one of the determined usages.

20. The method of claim 13, wherein generating the comparison comprises:
determining an amount of energy saved during the demand response event for a first one of the similar substations based on meter data for the first one of the similar substations;
determining an amount of energy saved during the demand response event for a second one of the similar substations based on meter data for the second one of the similar substations; and
comparing the amount of energy saved for the first one of the similar substations with the amount of energy saved for the second one of the similar substations, wherein the at least one customer is served by the first one of the similar substations.

21. The method of claim 13, wherein generating the comparison comprises:
determining an amount of energy saved during the demand response event for a first one of the similar substations based on meter data for the first one of the similar substations;
determining an average amount of energy saved during the demand response event for a plurality of the similar substations based on meter data for the plurality of the similar substations; and
comparing the amount of energy saved for the first one of the similar substations with the average amount of energy saved for the plurality of the similar substations, wherein the at least one customer is served by the first one of the similar substations.

22. The method of claim 13, wherein generating the comparison comprises:
determining an amount of energy saved during the demand response event for a first one of the similar substations based on meter data for the first one of the similar substations;
identifying an efficient one of the similar substations;
determining an amount of energy saved during the demand response event for the efficient one of the similar substations based on meter data for the efficient one of the similar substations; and
comparing the amount of energy saved for the first one of the similar substations with the amount of energy saved for the efficient one of the similar substations, wherein the at least one customer is served by the first one of the similar substations.

23. The method of claim 22, wherein identifying the efficient one of the similar substations comprises:
determining an amount of energy saved for each of the similar substations based on meter data for the similar substation; and
identifying one of the similar substations having a highest one of the determined amounts of energy saved.

24. A system, comprising:
a computer processor; and
a memory storing instructions that, when executed by the computer processor, cause the computer processor to:
identify at least two similar substations;
receive meter data for each one of the similar substations during a demand response event;
generate a comparison of usages of the similar substations during the demand response event based at least in part on the meter data for the similar substations; and
provide the comparison to at least one customer of the similar substations.

25. A non-transitory computer-readable medium storing instructions that, when executed by a computer processor, cause the computer processor to:
identify at least two similar substations;
receive meter data for each one of the similar substations during a demand response event;
generate a comparison of usages of the similar substations during the demand response event based at least in part on the meter data for the similar substations; and
provide the comparison to at least one customer of the similar substations.
